(19) United States
(12) Patent Application Publication
(10) Pub. No.: US 2025/0052709 A1
(43) Pub. Date: Feb. 13, 2025

(54) METHOD FOR STATE-OF-HEALTH MONITORING IN ELECTRIC VEHICLE DRIVE SYSTEMS AND COMPONENTS

(71) Applicants: Animesh KUNDU, Windsor (CA); Philip KORTA, Troy, MI (US); Lakshmi Varaha IYER, Troy, MI (US); Narayan C. KAR, Windsor (CA); MAGNA INTERNATIONAL INC., Aurora (CA)

(72) Inventors: Animesh KUNDU, Windsor (CA); Philip KORTA, Troy, MI (US); Lakshmi Varaha IYER, Troy, MI (US); Narayan C. KAR, Windsor (CA)

(21) Appl. No.: 18/722,616

(22) PCT Filed: Dec. 22, 2022
(86) PCT No.: PCT/US2022/053786

§ 371 Date: Jun. 21, 2024

Related U.S. Application Data
(60) Provisional application No. 63/292,540, filed on Dec. 22, 2021.

(51) Int. Cl. G01N 25/72

(52) U.S. Cl. CPC G01N 25/72

(57) ABSTRACT

A method for state-of-health monitoring of a powertrain component in an electric vehicle system includes: determining an equivalent circuit model of the powertrain component; modeling heat losses in the powertrain component considering both transient and steady-state conditions; modeling heat flow through the powertrain component based on one or more material properties of the powertrain component; determining a temperature of a particular structure within the powertrain component; and determining, using a Rainflow algorithm, a number of temperature cycles until failure of the particular structure based on the temperature of the particular structure.

### CROSS-REFERENCE TO RELATED APPLICATION

This PCT International Patent application claims the benefit of and priority to U.S. Provisional Patent Application Ser. No. 63/292,540 filed on Dec. 22, 2021 titled “Method For State-Of-Health Monitoring In Electric Vehicle Drive Systems And Components,” the entire disclosure of which is hereby incorporated by reference.

### FIELD

The present disclosure relates generally to methods for monitoring a state-of-health (SoH) of an electronic device of an inverter or a power module for single or multiple power devices.

### BACKGROUND

Many opportunities exist for improving performance of electric vehicle (EV) propulsion systems. For example, opportunities exist to improve efficiency, expand performance, advance connectivity, increase autonomy, reduce emissions, and to improve reliability. Recent research on EV powertrain has emphasized reliability analysis due to the advancement in power density, high temperature operation, and use of new materials.

Recent development on motor drive system for electric vehicle (EV) have introduced advanced power devices such as gallium nitride (GaN), silicon carbide (SiC), along with the existing insulated gate bipolar transistor (IGBT) and metal oxide semiconductor field effect transistor (MOSFET). Compact device packaging, optimized for heat dissipation, has been developed for many such advanced power devices. Also, the recent packaging development increases the power density of the inverter for EV applications. However, the increasing power density may compromise the reliability of the inverter. Therefore, a continuous state-of-health (SOH) monitoring system may be beneficial for determining reliability of an inverter power module. There are many challenges for power module reliability estimation, such as junction temperature tracking, continuous condition monitoring, fault diagnosis and prognosis due to limited access in the power module, accurate measurement and accurate reference data to compare degradation.

Some existing solutions may provide health monitoring of a device based on a case temperature measurement. For example, a case temperature may be compared with a threshold temperature value. The device may be considered to be faulty once the case temperature exceeds the threshold temperature value. However, such existing solutions may be unable to classify a type of fault in the device. Also, they may not isolate a specific faulty device in a power module.

### SUMMARY

The present disclosure provides a method for state-of-health monitoring of a powertrain component in an electric vehicle system. The method comprises: determining an equivalent circuit model of the powertrain component; modeling heat losses in the powertrain component considering both transient and steady-state conditions; modeling heat flow through the powertrain component based on one or more material properties of the powertrain component; determining a temperature of a particular structure within the powertrain component; and determining, using a Rainflow algorithm, a number of temperature cycles until failure of the particular structure based on the temperature of the particular structure.

The present disclosure also provides a system for state-of-health monitoring of a powertrain component in an electric vehicle system. The system includes a processor; and a memory including instructions. The instructions, when executed by the processor, cause the processor to: determine an equivalent circuit model of the powertrain component; determine an estimate of heat losses in the powertrain component considering both transient and steady-state conditions; determine an estimate of heat flow through the powertrain component based on one or more material properties of the powertrain component; determine a temperature of a particular structure within the powertrain component; and determine, using a Rainflow algorithm, a number of temperature cycles until failure of the particular structure based on the temperature of the particular structure.

### BRIEF DESCRIPTION OF THE DRAWINGS

Further details, features and advantages of designs of the invention result from the following description of embodiment examples in reference to the associated drawings.

FIG. 1 shows a flow diagram of a first method for determining remaining useful life of a selected powertrain component;

FIG. 2 shows a cross sectional view of a power module including an insulated gate bipolar transistor (IGBT);

FIG. 3 shows a schematic block diagram of a system for determining remaining useful life of a selected powertrain component, in accordance with an aspect of the present disclosure;

FIG. 4 shows flowchart for a state-of-health (SoH) model according to an aspect of the present disclosure;

FIG. 5 shows a schematic diagram showing a double-pulse test circuit;

FIGS. 6A-6B show graphs of IGBT energy dissipation during turn-on and turn-off;

FIG. 6C shows graphs of diode energy dissipation during turn-off;

FIG. 7 shows a Cauer thermal network model of layers and geometry in a power module;

FIG. 8 shows an image of a power module with coloration indicating temperature;

FIG. 9 shows a flowchart illustrating steps in a method for monitoring and characterizing SoH of an inverter, according to an aspect of the present disclosure;

FIG. 10 shows a flowchart illustrating steps in a method for monitoring and characterizing SoH of a powertrain component based on degradation of a particular structure within the powertrain component and based on calculated and measured case temperatures, according to an aspect of the present disclosure;

FIG. 11 shows a graph of junction temperature over time;

FIG. 12 shows a Rainflow matrix, according to an aspect of the present disclosure;

FIG. 13 shows a diagram listing functions in a method for estimating Remaining Useful Life, according to an aspect of the present disclosure;

FIG. 14 shows a graph plotting number of cycles to failure as a function of average temperature and as a function of temperature variation, according to an aspect of the present disclosure;

FIG. 15 shows a graph showing an SN curve for solder in a Si-IGBT device, according to an aspect of the present disclosure; and

FIG. 16 shows a graph showing an SN curve for silicon material in a Si-IGBT device, according to an aspect of the present disclosure.

FIG. 17 shows a flowchart illustrating steps in a method for monitoring and characterizing SoH of power modules of an inverter, according to an aspect of the present disclosure;

FIG. 18 shows schematic diagram of a circuit configured to apply a double pulse test (DPT) to a device under test (DUT);

FIG. 19 shows a graph of voltage and current characteristics of an IGBT-diode module;

FIG. 20A shows a graph illustrating change in thermal conductivity for different materials as a function of temperature;

FIG. 20B shows a graph illustrating change in heat capacity for different materials as a function of temperature;

FIG. 21A shows a graph illustrating increases in thermal resistance in individual layers, over time;

FIG. 21B shows a graph illustrating temperature changes in the power cycle method, as a function of a number of cycles;

FIG. 21C shows a graph illustrating simulated and experimental (measured) resultant thermal resistance, over time;

FIG. 21D shows a graph illustrating simulated and experimental (measured) junction temperatures, as a function of a number of cycles;

FIG. 22 shows a schematic diagram including a flow chart illustrating a method for identifying a temperature-based packaging fault in an inverter, according to an aspect of the present disclosure;

FIG. 23 shows a schematic diagram of a circuit for measuring turn-on voltage of a semiconductor device including an IGBT and a diode;

FIG. 24A shows a graph illustrating turn-on voltage as a function of current and with plots representing different junction temperatures;

FIG. 24B shows a graphic representation of data in a look-up table after interpolation and correlating turn-on voltage with each of Current and Temperature;

FIG. 25A shows a graph illustrating IGBT junction temperature over a number of cycles;

FIG. 25B shows a graph illustrating difference in junction temperature over a number of cycles;

FIG. 25C shows a graph illustrating simulated and experimental (measured) differences in junction temperature over a number of cycles;

FIGS. 26A and 26B each show a graph illustrating numbers of temperature cycles counted with a Rainflow algorithm and as a function of temperature swing and mean temperature;

FIG. 27A shows a graph illustrating a total number of lifecycles as a function of each of average temperature and difference in temperature;

FIG. 27B shows a graph illustrating degradation for Si and solder (Sn) layers, over a number of cycles;

FIG. 28 shows a graph illustrating accumulated material degradation of a silicon layer in online condition;

FIG. 29 shows a schematic diagram of an applied power cycling test circuit for SOH monitoring; and

FIG. 30 shows a graph illustrating a current as a function of time for a repetitive load condition.

### DETAILED DESCRIPTION

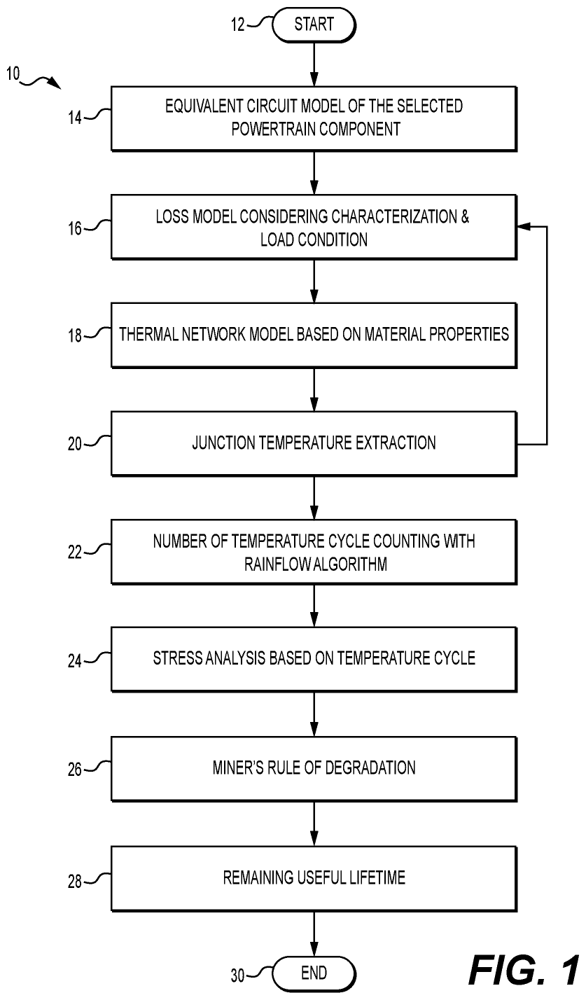

Referring to the drawings, the present invention will be described in detail in view of following embodiments. The present disclosure provides a method for estimating the reliability of any powertrain component of an electric vehicle (EV). The method is applicable for any powertrain equipment such as battery, DC bus capacitor, motor drive, and AC motor insulation. A first method for temperature-dependent reliability or state-of-health (SoH) monitoring of a powertrain component is presented in FIG. 1.

The first method 10 starts at 12 and proceeds to determining an equivalent circuit model of the powertrain component at step 14.

The first method 10 proceeds with modeling heat losses in the powertrain component considering both transient and steady-state conditions at step 16.

The first method 10 also includes modeling heat flow through the powertrain component based on one or more material properties of the powertrain component at step 18.

The first method 10 also includes determining a temperature of a particular structure within the powertrain component at step 20. For example, the particular structure may be a junction in an insulated gate bipolar transistor (IGBT).

The first method 10 also includes determining, using a Rainflow algorithm, a number of temperature cycles until failure of the particular structure based on the temperature of the particular structure at step 22.

The first method 10 also includes determining an applied stress in the particular structure based on temperature cycling of the particular structure at step 24.

The first method 10 also includes applying Miner's rule for modeling cumulative damage at step 26.

The first method 10 also includes determining a remaining useful lifetime of the powertrain component at step 28.

The first method 10 ends at step 30, wherein it may re-start or be applied to one or more powertrain components, etc.

The health monitoring of the inverter power module is directly related to accurate temperature monitoring. The available temperature monitoring system focuses mostly at the junction of the silicon chip and the baseplate layer of the power module. However, there are other layers such as bond wire, solder layers adjacent to silicon and baseplate are also need to be monitored for accurate health monitoring. Also, the cross-coupling effect between two devices has significant influence in thermal analysis due to recent improvement in power density. Existing thermal network model considers the cross-coupling effect in finite element analysis (FEA) in offline condition, which is not effective in unwanted load fluctuation.

The temperature tracking is used for inverter reliability and health monitoring. Number of temperature cycle is calculated based on the temperature variation due to the selected load profile. Conventional Rainflow algorithm is mostly used for cycle counting. However, the process is used for non-invasive method. Finally, the module degradation is being monitored using the Miner's rule. The conventional cycle counting and the degradation methods are used for offline analysis for the reliability estimation at the healthy condition of the inverter. Therefore, the estimated lifetime of the inverter is not accurate with time.

For accurate reliability or state-of-health monitoring, research has been conducted on condition monitoring of the fragile element of the power module such as wire bond, and solder layer of the power module. Previous research shows the offline prognosis method using the temperature sensitive electric parameters (TSEPs) such as collector-emitter voltage, resistance, gate voltage, and case temperature etc. The research is conducted on the solder fatigue in FE analysis based on the power cycling load condition. However, it is challenging to include crack propagation and monitor the post fault operation. Similarly, the bond wire lift off is also identified by repetitive power cycling test. Previous research shows the bond wire fatigue identification using the TSEPs such as collector-emitter voltage or gate current. However, the fatigue estimation based on power cycling test is predictable and only works for specific load profile. Therefore, such conventional fatigue-estimation methods may not provide accurate estimations during varying or random load profiles, such as those experienced in real-world applications.

An objective of the proposed model is to monitor state-of-health (SoH) of the electric vehicle (EV) powertrain components such as battery, DC bus capacitor, inverter power module, gate driver components, motor insulation, and permanent magnet of AC synchronous machine and insulation of AC machine. The developed model considers the temperature variation of the selected components to analyze the total stress advancing towards end of lifetime by gradually degraded material. A modified Rainflow algorithm and Arrhenius models are used to identify the stress on the selected device. In this disclosure, the proposed model is being applied to inverter power module for validation. Subsequently, the proposed method develops an initial fault identification and classification method due to gradually degraded material of power module.

According to an aspect of the present disclosure, a method for calculating degradation of material in an inverter power module over random load conditions and based on the junction temperature variation at each node of the power module is provided.

In some embodiments, a model is developed using a Cauer-based thermal network model to track junction temperature at each node of the power module. Temperature changes due to load variation causes the material degradation. According to an aspect of the disclosure, the provided method estimates the material degradation based on temperature variation. Furthermore, increasing power module case temperature may effect likelihood of different types of faults in the package. Therefore, it may be beneficial to classify the fault for device performance analysis. In the method of the present disclosure, case temperature-based solder fatigue and collector-emitter voltage based bond wire liftoff fault diagnosis are provided. Subsequently, an online Rainflow-based temperature cycle counting method is provided for continuous health monitoring.

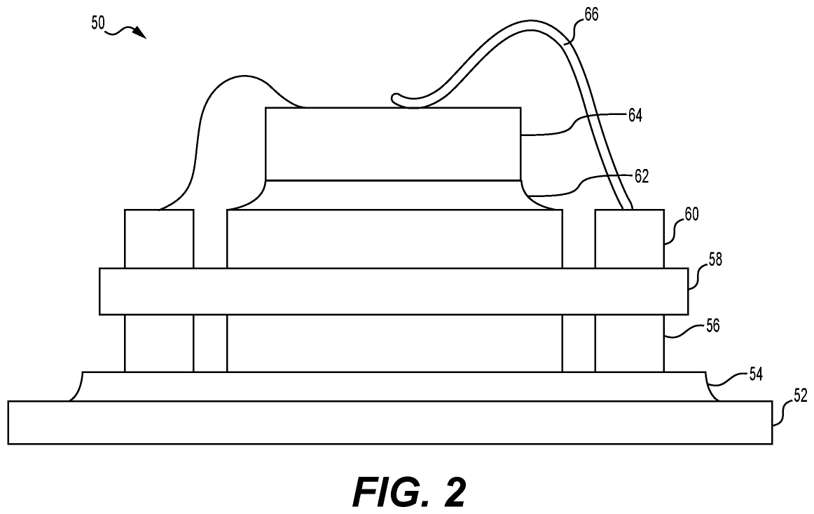

Recent development in electric vehicles (EVs) shows improved packaging quality in power electronics devices for increase in power density and optimized heat dissipation. FIG. 2 shows a powertrain component in the form of a power electronic module 50 with seven layers. The power electronic module 50 shown in FIG. 2 includes an insulated gate bipolar transistor (IGBT) and is used to illustrate the method of the present disclosure. However, the method of the present disclosure may be applied to other types of power modules and/or to other types of powertrain components.

The power electronic module 50 includes a baseplate 52, which may include an electrical insulator layer, such as fiberboard or ceramic material. A first solder layer 54 is disposed on top of the baseplate 52. A first metal layer 56, such as copper, is disposed on top of the first solder layer 54, with the first solder layer 54 extending between the first metal layer 56 and the baseplate 52 for securing those layers together and for transmitting heat therebetween. A ceramic layer 58 overlies the first metal layer 56 and is disposed parallel and adjacent thereto. A second metal layer 60, such as copper, is disposed on top of the ceramic layer 58 and is disposed parallel and adjacent thereto. A second solder layer 62 overlies the second metal layer 60. A semiconductor chip 64 is disposed on top of the second solder layer 62 and is bonded thereto. A wire bond 66 extends from an upper surface of the semiconductor chip 64, opposite from the second solder layer 62, and provides an electrical connection to the second metal layer 60.

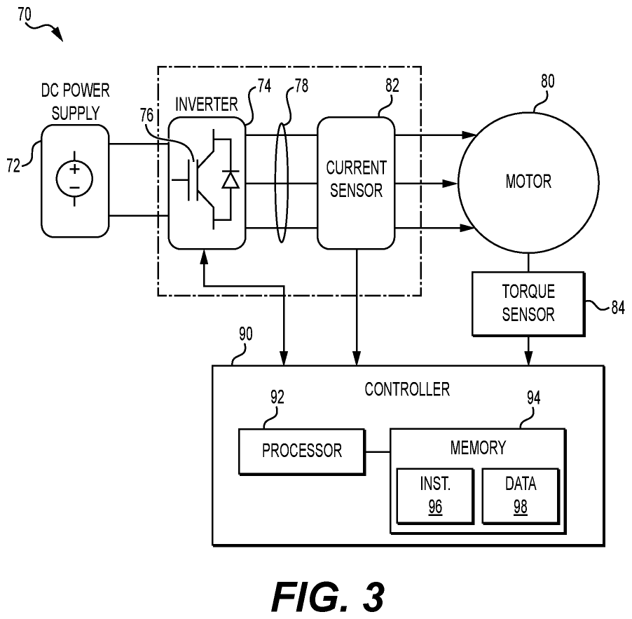

FIG. 3 shows a schematic block diagram of a system 70 for determining remaining useful life of a selected powertrain component. The system 70 includes a direct current (DC) power supply 72, such as a battery pack or a DC bus transmitting DC power from a rectifier or another source. The system 70 also includes an inverter 74 including a plurality of power switches 76 (only one representative power switch 76 is shown) that generates, using power from the DC power supply, alternating current (AC) power on a set of motor leads 78 for application to windings of an electric motor 80. A current sensor 82 measures electrical current on one or more of the motor leads 78. For example, the current sensor 82 may measure phase currents on each of the motor leads 78. A torque sensor 84 measures actual torque produced by the electric motor 80.

The system 70 includes a controller 90 for controlling various functions. The controller 90 may control operation of the inverter 74. For example, the controller 90 may generate one or more control signal for controlling conductive states of the power switches 76 for generating the AC power. In some embodiments, the controller 90 may control may control other functions and/or components within the system 70. The controller 90 is connected to each of the current sensor 82 and the torque sensor 84 for receiving respective signals therefrom. The controller 90 includes a processor 92 coupled to a storage memory 94. The storage memory 94 includes an instruction storage 96 storing instructions, such as program code for execution by the processor 92. The storage memory 94 also includes a data storage 98 for holding data for use by the processor 92. The data storage 98 may record, for example, the outcome of functions calculated by the processor 92 and/or values of parameters measured by one or more sensors, such as the current sensor 82 and the torque sensor 84. The system 70 may represent a model of a powertrain for an electrified vehicle (EV).

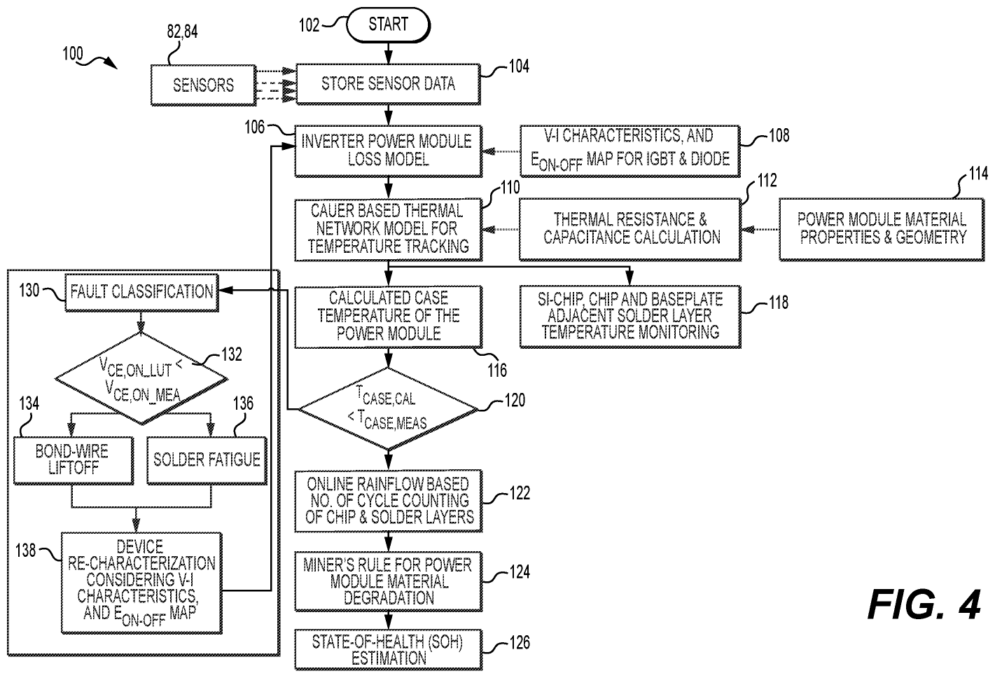

FIG. 4 shows a block diagram of a workflow for a second method 100 to model integrated state-of-health (SoH). In some embodiments, the second method 100 includes a complete degradation analysis, inverter loss model, thermal network model, packaging-related fault identification model, and a degradation model. The second method 100 may take, as inputs, measured 3-phase currents I_{a,b,c} from the current sensor 82 and a measured case temperature T_{cm} of a power electronic module 50, which may include one or more of the power switches 76 of the inverter 74.

The second method 100 starts at 100 and includes storing sensor data at 104. For example, step 104 may include the processor 92 storing data based on readings from the current sensor 82 and the torque sensor 84.

The second method 100 proceeds by computing an inverter power loss at step 106. For example, step 104 may include the processor 92 computing power loss by the inverter 75. The second method 100 also includes determining, at step 108, voltage vs. current (V-I) characteristics and E_{ON-OFF} of an IGBT and diode in the power switches 76. For example, step 108 may include the processor 92 referencing one or more tables or performing one or more computations to determine the V-I characteristics and E_{ON-OFF}. The V-I characteristics and E_{ON-OFF} of the IGBT and diode may be used for computing the inverter power loss at step 106.

The second method 100 proceeds by determining a Cauer-based thermal network model for temperature tracking at step 110. For example, the processor 92 may execute instructions for implementing the Cauer-based thermal network model. The second method 100 also includes determining thermal resistance and capacitance at step 112. For example, step 112 may include the processor 92 executing instructions for calculating the thermal resistance and capacitance of the power electronic module 50. The second method 100 also includes determining material properties and geometry of the power electronic module 50 at step 114. For example, the material properties and geometry of the power electronic module 50 may be stored in the data storage 98 and retrieved by the processor 92 for use in determining material properties and geometry of the power electronic module 50 at step 114.

The second method 100 proceeds by determining a calculated case temperature T_{CASE,CAL} of the power electronic module 50 at step 116. For example, the processor 92 may execute instructions for calculating case temperature of the power electronic module 50 based on an output of the Cauer-based thermal network model.

The second method 100 also includes monitoring temperatures of other components of the power electronic module 50 at step 118. For example, the processor 92 may execute instructions for calculating temperatures of the baseplate 52, the first solder layer 54, the second solder layer 62, and/or the semiconductor chip 64, and based on an output of the Cauer-based thermal network model.

The second method 100 also includes determining, at step 120, if the calculated case temperature T_{CASE,CAL} of the power electronic module 50 is greater than a measured value of the case temperature T_{CASE,MEAS} of the power electronic module 50. If the calculated case temperature T_{CASE,CAL} of the power electronic module 50 is greater than the measured value of the case temperature T_{CASE,MEAS} of the power electronic module 50, the second method 100 may proceed to classify a fault at step 130. Otherwise, the second method 100 may proceed to steps 122-126 to estimate a state-of-health (SoH) due to gradually degraded material within the power electronic module 50.

The second method 100 also includes determining, at step 122, using an online Rainflow-based temperature cycle counting method, a cycle count of the components within the power electronic module 50. For example, the processor 92 may execute instructions for implementing the online Rainflow-based temperature cycle counting method of the present disclosure.

The second method 100 proceeds with computing, at step 124, a material degradation of the components within the power electronic module 50 using Miner's rule. For example, the processor 92 may execute instructions for implementing the Miner's rule computation of the present disclosure to determine the degradation of the components within the power electronic module 50.

The second method 100 proceeds with estimating, at step 126, the state-of-health (SoH) of the power electronic module 50 based on the degradation of the components within the power electronic module 50. For example, the processor 92 may execute instructions for estimating the SoH of the power electronic module 50 or one or more components therein, based on the material the degradation of the components determined at step 124.

The second method 100 also includes classifying a fault within the power electronic module 50 at step 130. The second method 100 proceeds with determining, at step 132, whether a lookup-table based value for collector-emitter turn-on voltage V_{CE,ON_LUT} is less than a measured value of the collector-emitter turn-on voltage V_{CE,ON_MEA}.

The second method 100 also includes classifying, at step 134, a fault in the power electronic module 50 as a bond-wire liftoff, based on the comparison between the lookup-table based value for collector-emitter turn-on voltage V_{CE,ON_LUT} and the measured value of the collector-emitter turn-on voltage V_{CE,ON_MEA}.

The second method 100 also includes re-characterizing the power electronic module 50, at step 138, based on the classification of the fault from steps 134-136 and considering voltage/current (V-I) characteristics and an E_{ON-OFF} map. This re-characterization of the power electronic module 50 may be used by the inverter power module loss module to improve the accuracy of that model during an execution of step 106 in a subsequent iteration of the second method 100.

According to an aspect of the disclosure, the integrated SoH model includes a comprehensive analytical loss model considering both transient and steady-state conditions. A steady-state loss model considers conduction and switching losses based on device electrical characteristics such as voltage-current, switching energy envelop. For accurate parameter identification, a double pulse test (DPT) is used.

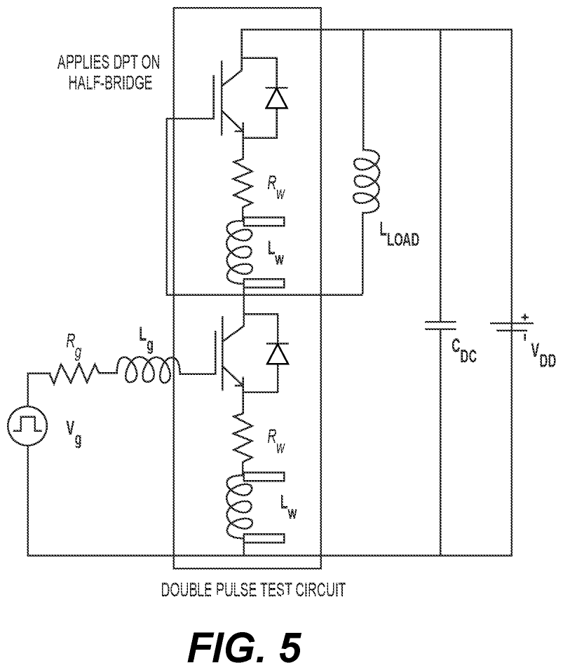

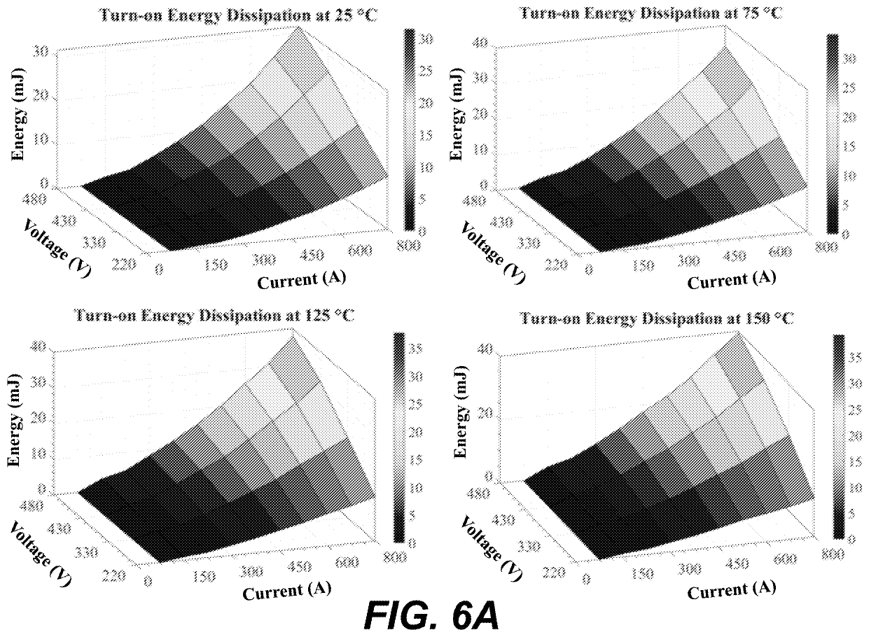

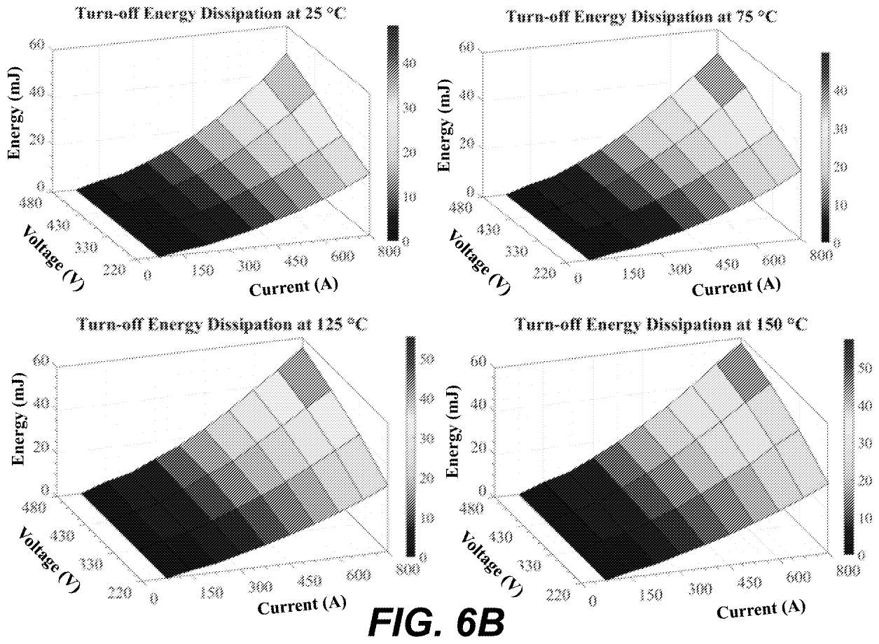

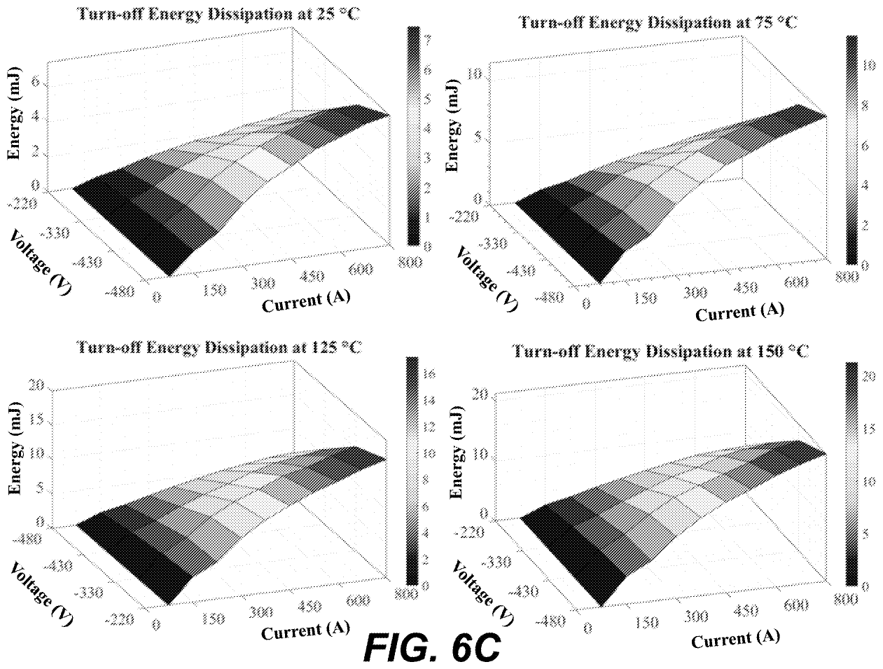

FIG. 5 shows a schematic diagram showing a double-pulse test circuit used to perform the DPT. The DPT may be conducted at different ambient temperatures and DC voltages. Results of the DPT, showing energy dissipation as a function of collector-emitter voltage and collector current, are shown in the graphs of FIGS. 6A-6C. FIG. 6A shows graphs of IGBT energy dissipation during turn-on and at 25° C., 75° C., 125° C.′, and 150° C., and FIG. 6B shows graphs of IGBT energy dissipation during turn-off at 25° C. 75° C., 125° C., and 150° C., and FIG. 6C shows graphs of diode energy dissipation during turn-off at 25° C., 75° C., 125° C., and 150° C.

The transient loss model may include deadtime harmonics, charging and discharging of the input and output capacitance of the device considering the gate current. The total loss has been calculated combining the transient and steady-state losses for both IGBT and diode.

Next, the method of the present disclosure uses a thermal network model to track junction and case temperatures of the power module. The thermal network model may use a Foster network model or a Cauer network model. However, other types of network models may be used. A Foster network model is a non-invasive method that may be used to develop the analytical model based on the temperature rise and fall time. The Cauer network model is developed based on the device material and geometry information. For SoH monitoring, it may be important to track the temperature variation at each layer of the power module.

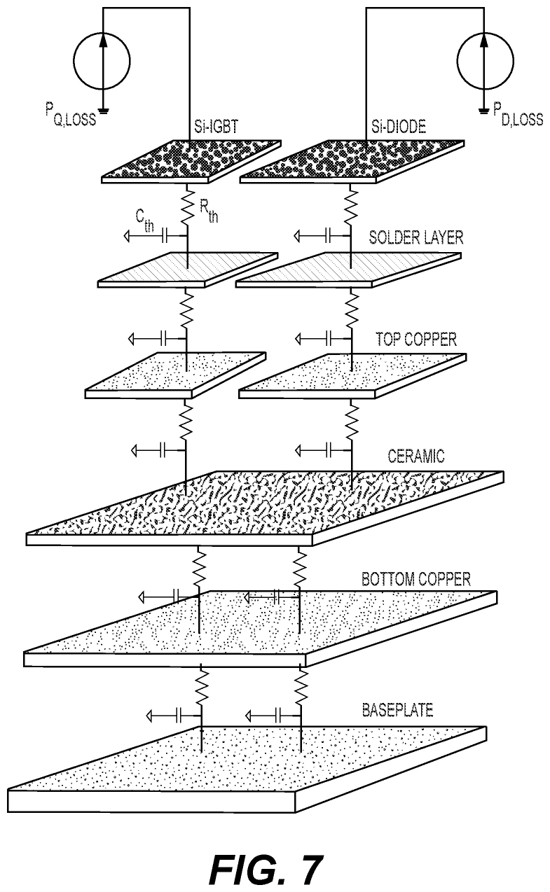

FIG. 7 shows a Cauer thermal network model of layers and geometry in a power module and used for the SoH analysis in the method of the present disclosure. FIG. 7 may represent an equivalent circuit model of an inverter power module that includes an insulated-gate bipolar transistor (IGBT) and a diode. The inverter power module of FIG. 7 may include the of the power electronic module 50. The inverter power module of FIG. 7 may form a power switch 76 of the inverter 74.

The Cauer thermal network model includes resistor-capacitor (RC) components calculated based on the material information of each layer and geometry of the power module. Also, the heat propagation angle is considered for accurate RC component calculation. The cross-coupling between IGBT and diode dies are considered from finite element analysis (FEA), as illustrated in FIG. 8, which shows the power module with coloration indicating temperature. The thermal network model observes the temperature at Si-die, and the solder layer attached to Si-die and baseplate. The bond wire may be not included in the thermal network model as it has relatively low effect on temperature.

In some embodiments a Rainflow-based temperature cycle counting method is applied to identify number of repetitive cycle due to the load applied to the inverter power module. The process classify temperature variation into half and full cycles along with the minimum, maximum, and mean temperature of each identified cycle. The conventional Rainflow algorithm is applied for offline calculation. Hence, the conventional Rainflow cannot be used for continuous health monitoring in online condition. The method of the present disclosure may include a modified version of the Rainflow cycle counting method, based on the time-dependent optimum data storage method for online health monitoring system. Finally, Miner's rule is applied to calculate the material degradation of the power module.

According to an aspect of the present disclosure, the method for developing and using an SOH model can be used for any EV powertrain equipment.

According to an aspect of the present disclosure, a loss model of the Inverter power module is developed considering steady-state and transient conditions. The developed loss model includes a steady-state loss model of conduction and switching losses based on the device voltage-current characteristics and energy dissipation due to fast switching. Considered parameters of the loss model are updated considering the degradation of the device power module materials.

According to an aspect of the present disclosure, an advanced Cauer-based thermal network model is used to track temperature and heat flow at each layer of the power module considering change in thermal conductivity and specific heat due to material degradation.

In some embodiments, the method and system of the present disclosure provide continuous monitoring of power module materials degradation based on temperature variation and applied stress.

In some embodiments, the method and system of the present disclosure provide a fault diagnosis and prognosis method to identify solder fatigue and bond-wire liftoff fault using existing sensors such as case temperature and 3-phase load currents. The developed method may provide fast, easier, and accurate way to classify device packaging faults.

In some embodiments, the method and system of the present disclosure may be implemented in an online condition by altering the Rainflow cycle counting method and online junction and case temperature monitoring.

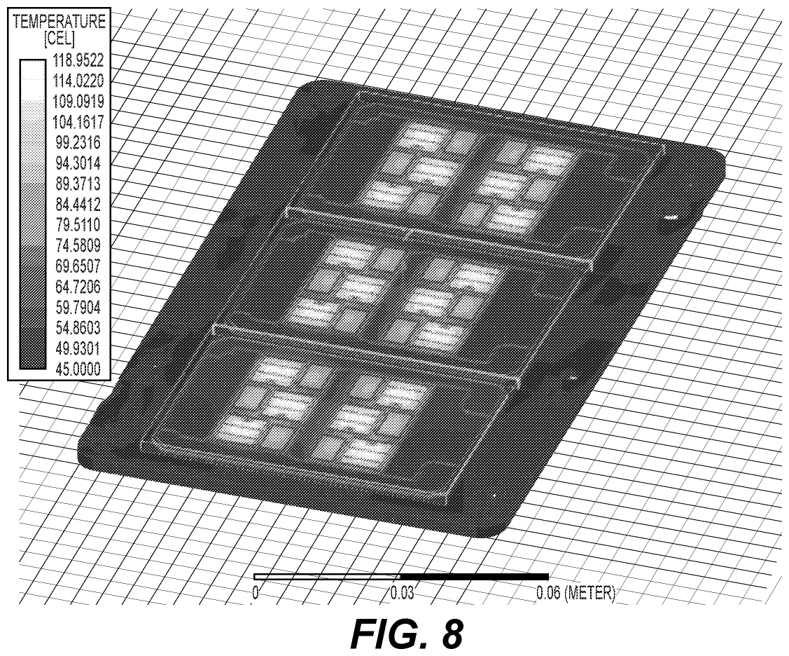

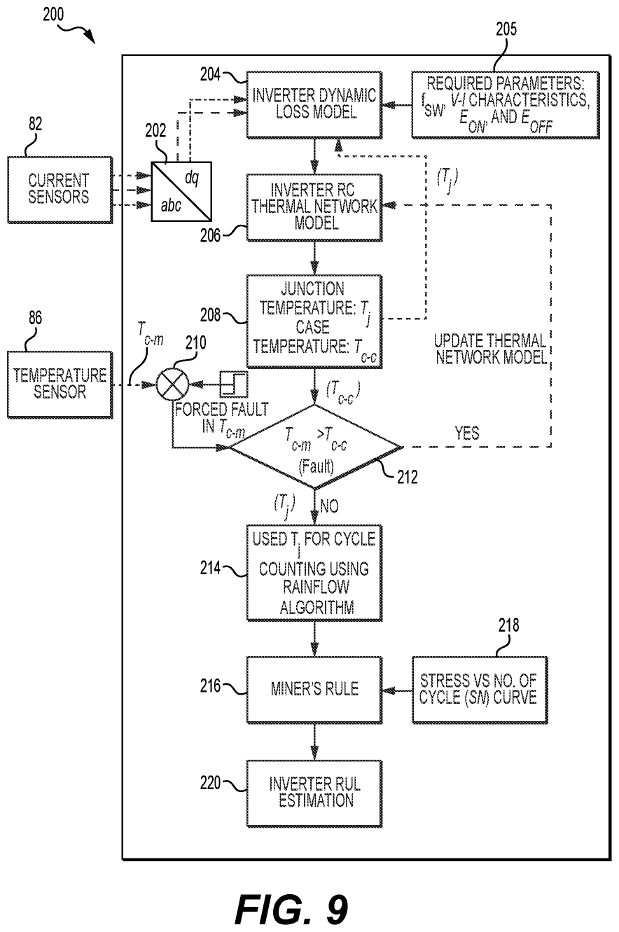

FIG. 9 shows a block diagram of a third method 200 for monitoring and characterizing SoH of an inverter. The block diagram of FIG. 9 describes steps in the method considering material degradation and fault diagnosis over a continuous load condition. The third method 200 takes, as inputs, phase currents I_{a,b,c} from the current sensor 82, and a measured case temperature T_{c-m} of a case of the inverter 74, as measured by a temperature sensor 86.

The third method 200 includes converting, at step 202, the phase currents I_{a,b,c} to d-axis and q-axis currents. For example, the processor 92 may execute instructions for implementing a transform to calculate the d-axis and q-axis currents based on the phase currents I_{a,b,c}.

The third method 200 also includes calculating a dynamic loss in the inverter at step 204, using an inverter dynamic loss model and based on the d-axis and q-axis currents. For example, the processor 92 may execute instructions for implementing the inverter dynamic loss model.

The third method 200 also includes determining, at step 205, one or more required parameters for the inverter dynamic loss model. The required parameters may include a switching frequency f_{SW}, V-I characteristics, E_{ON}, and E_{OFF}. For example, step 205 may include the processor 92 referencing one or more tables or performing one or more computations to determine the values of the required parameters for the inverter dynamic loss mode. The required parameters, such as values of the switching frequency f_{SW}, V-I characteristics, E_{ON}, and E_{OFF} may be used for calculating the dynamic loss in the inverter at step 204.

The third method 200 also includes modeling, at step 206, a thermal network model of at least a component of the inverter 74. For example, the processor 92 may execute instructions for implementing a thermal network model of resistor-capacitor (RC) components of the Cauer based thermal network model shown in FIG. 7.

The third method 200 also includes determining, at step 208, a junction temperature Tⱼ and a computed case temperature T_{c-c}. The junction temperature Tⱼ and the estimated case temperature T_{c-c} may be determined, for example, by the processor 92 and based on an output of the model of step 206. The third method 200 may include supplying the junction temperature Tⱼ to the inverter dynamic loss model to improve the inverter dynamic loss model of step 204 in a subsequent iteration of the third method 200.

The third method 200 also includes multiplying, at step 210, the measured case temperature T_{c-m} by a forced fault value to determine an adjusted measured temperature. The forced fault value may include for example, a zero value to indicate a fault in the measured temperature to force the measured case temperature T_{c-m} not to be used for subsequent computation.

The third method 200 also includes determining, at step 212, whether the adjusted measured case temperature T_{c-m}, as produced by step 210 is greater than the estimated case temperature T_{c-c}, indicating a fault. For example, the processor 92 may execute instructions for comparing the adjusted measured case temperature T_{c-m} to the estimated case temperature T_{c-c} or to another value based on the estimated case temperature, such as a fault-indicative temperature based on the estimated case temperature T_{c-c} plus some offset. The third method 200 may return to step 206 in response to determining, at step 212, that the adjusted measured case temperature T_{c-m} is indicative of a fault. The third method 200 may proceed to step 214 in response to determining, at step 212, that the adjusted measured case temperature T_{c-m} is not indicative of a fault, for example by determining that the adjusted measured case temperature T_{c-m} is equal to or within a predetermined variance of the estimated case temperature T_{c-c}.

The third method 200 also includes using the junction temperature Tⱼ for cycle counting using a Rainflow algorithm at step 214. For example, the processor 92 may execute instructions for implementing the Rainflow algorithm of the present disclosure to estimate a number of temperature cycles until failure of a corresponding power switch 76 within the inverter 74.

The third method 200 proceeds with estimating at step 216, using Miner's rule, an estimated remaining useful life (RUL) 220 of the inverter 74. Step 216 may take, as an input, stress data 218 representing an SN curve of stress vs. a number of temperature cycles. The stress data 218 may be stored in the data storage 98 of the storage memory 94. The processor 92 may execute instructions for implementing the Miner's rule of step 216 in order to calculate the estimated RUL 220.

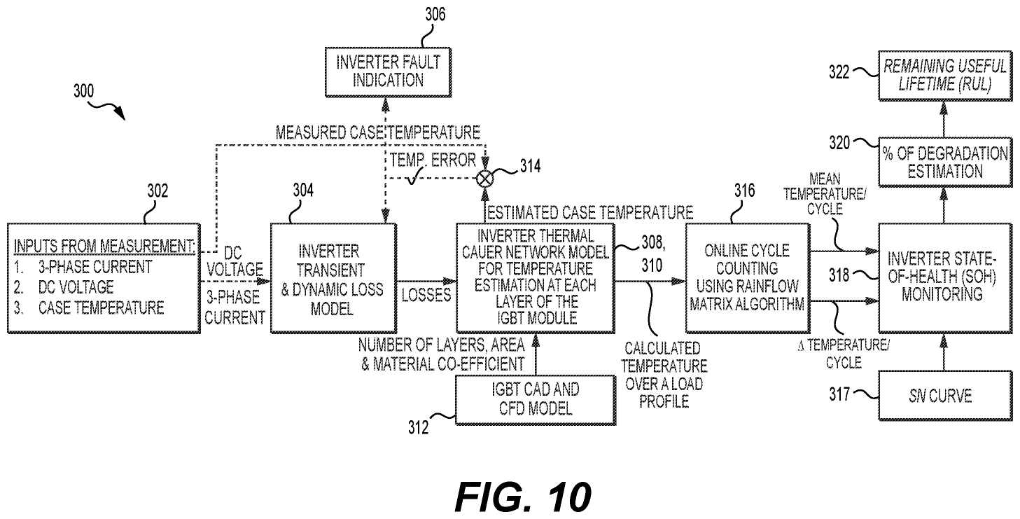

FIG. 10 shows a block diagram of a fourth method 300 for monitoring and characterizing SoH of a powertrain component based on degradation of a particular structure within the powertrain component and based on calculated and measured case temperatures. The particular structure may include, for example, a solder layer in a power switch 76 of the inverter 74. The fourth method 300 takes as inputs 302, phase currents I_{a,b,c} from the current sensor 82, a DC voltage VDC that is supplied to the power switch 76 of the inverter 74, and a measured case temperature T_{c-m} of a case of the inverter 74, as measured by a temperature sensor 86.

The fourth method 300 includes computing, at 304, inverter losses in the inverter 74 using a model of transient and dynamic losses. For example, the processor 92 may execute instructions for implementing the model in order to determine the inverter losses based on the phase currents I_{a,b,c} and the DC voltage VDC.

The fourth method 300 includes indicating, at 306, an inverter fault, based on the inverter losses computed at step 304. For example, if the inverter losses exceed a predetermined threshold, step 306 may cause a fault indicator, such as an indicator light, to be displayed. Alternatively or additionally, step 306 may include logging a diagnostic trouble code in a storage memory regarding the inverter fault.

The fourth method 300 includes calculating an estimated case temperature T_{c-c} at 308. The fourth method 300 also includes calculating a temperature overload profile at 310. In some embodiments, and as shown in FIG. 10, steps 308 and 310 may be combined and each performed using a Cauer network model for temperature estimation at each layer of an IGBT model, such as the model shown in FIG. 7. Steps 308 and 310 may take, as an input, a physical model (i.e. a CAD model) and/or a computational fluid dynamics (CFD) model 312 of the power switch 76. Steps 308 and 310 may include, for example, the processor 92 executing instructions for implementing the Cauer network model for temperature estimation.

The fourth method 300 includes computing, at 314, a temperature error. For example, the processor 92 may execute instructions for computing the temperature error as a difference between the measured case temperature T_{c-m} and the estimated case temperature T_{c-c}. Step 306 may include determining the inverter fault based on the temperature error. For example, step 306 may enunciate and/or log an inverter fault based on the temperature error exceeding a predetermined value.

The fourth method 300 includes determining, at 316, using an online Rainflow-based cycle counting method, and based on the temperature overload profile calculated at step 310, a mean temperature per cycle and a temperature difference (i.e. a Δ temperature) per cycle. For example, the processor 92 may execute instructions for implementing the online Rainflow-based temperature cycle counting method of the present disclosure.

The fourth method 300 includes determining, at 318, a state-of-health (SoH) of the inverter 74, based on the mean temperature per cycle and the temperature difference determined at step 316. For example, the processor 92 may execute instructions for estimating the SoH of the power electronic module 50 or one or more components therein, based on the material the degradation of the components determined at step 124. Step 318 may also take, as an input, an SN curve data 317, representing an SN curve of stress vs. a number of temperature cycles. The SN curve data 317 may be stored in the data storage 98 of the storage memory 94.

The fourth method 300 includes also includes determining, at 320, and based on the SoH determined at 318, a percentage of degradation estimation. The fourth method 300 includes also includes determining, at 322, and based on the SoH determined at 318, a remaining useful lifetime (RUL) of the power switch 76 of the inverter 74 and/or a RUL of the inverter 74.

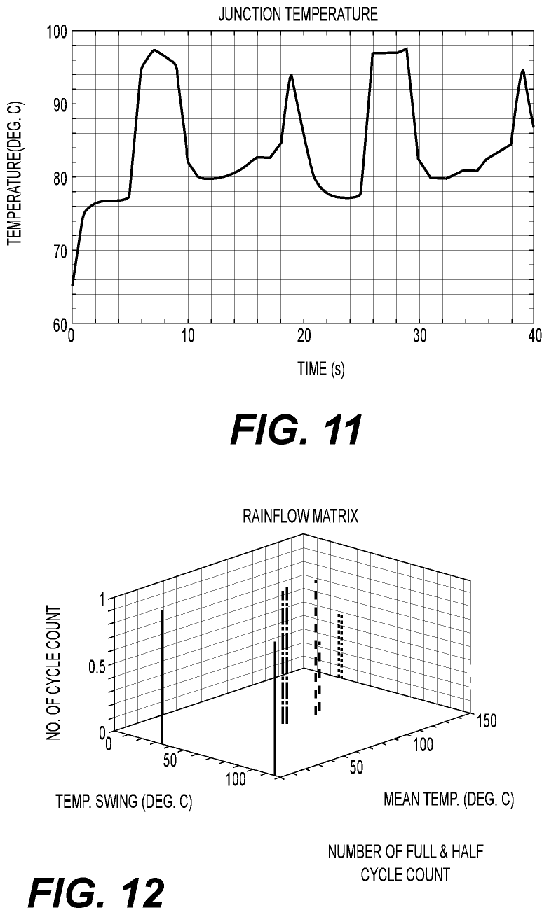

FIG. 11 shows a graph of junction temperature over time, and FIG. 12 shows a Rainflow matrix showing number of duty cycles to failure as a function of temperature swing and as a function of mean temperature. The number of temperature cycles until failure of the particular structure based on the temperature of the particular structure may be determined using a Rainflow algorithm. An equation for the Rainflow Algorithm is provided in equation (1) below:

$${{N}_{f} = A}_{Scaling {Factor}^{}} \cdot {\underbrace{Δ {T}_{j}^{- {β}_{1}}}}_{{Coffin -}_{Manson Law}} \cdot {\underbrace{{e}^{( \frac{α}{{T}_{j , mean} + 273} )}}}_{{Arrhenius}_{Equation}} {\underbrace{\cdot {t}_{on}^{- {β}_{2}}}}_{{Pulse -}_{Duration}} {\underbrace{\cdot {I}_{c}^{- {β}_{3}}}}_{{Current}_{Per Bond}} {\underbrace{\cdot {V}_{c}^{- {β}_{4}}}}_{{{Voltage}_{Per}}_{Switch}} {\underbrace{\cdot {D}^{- {β}_{5}}}}_{{{Bond -}_{wire}}_{Diameter}} \qquad ( 1 )$$

where N_{f} is the number of cycles to failure, Tⱼ is the junction temperature, and where A is a scaling factor, α is a constant equal to −5.039, E_{α} is an activation energy of the material, k_{B} is the Boltzman constant, 1.38 E-23, and Tⱼ is a junction temperature in degrees Kelven. The junction temperature Tⱼ, may be a measured or estimated junction temperature. The term ΔTⱼ^{-α} is a Coffin-Manson expression relating cycles to failure to plastic strain amplitude, and

$${e}^{( \frac{{E}_{a}}{{k}_{B} {T}_{jm}} )}$$

is the Arrhenius equation for the temperature dependence of reaction rates.

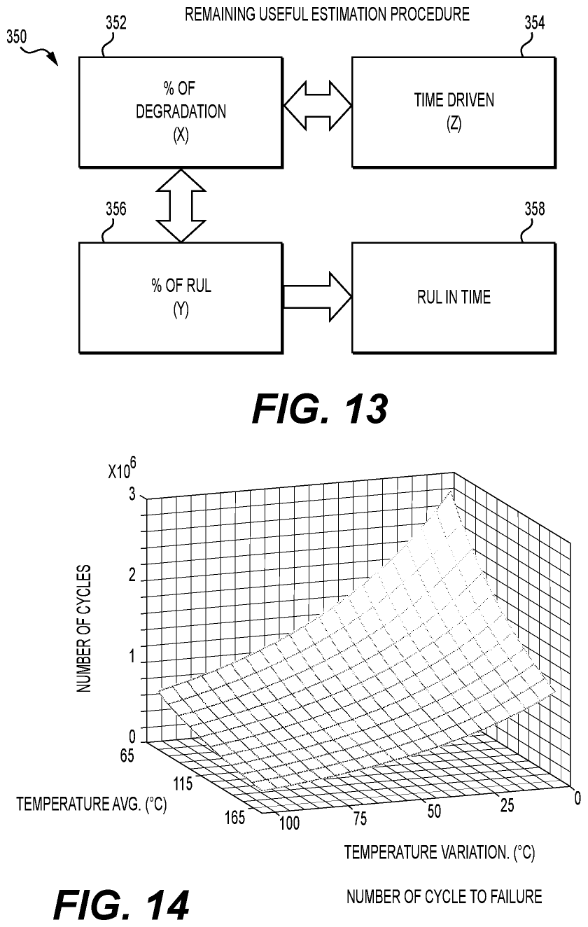

FIG. 13 shows a diagram listing functions in a method 350 for estimating Remaining Useful Life (RUL) of a powertrain component, which may be determined using equation (2), below:

$$RUL = \frac{y \times z}{x} \qquad ( 2 )$$

where x is a percentage of degradation, z is a time that the powertrain component has already been used, y is a percentage of remaining useful life remaining.

The method 350 includes a first function 352 for determining the percentage of degradation (x). The method 350 also includes a second function 354 for determining the time that the powertrain component has already been used (z), which may also be called “time driven”. The method 350 also includes a third function 356 for determining the percentage of RUL (y). The method 350 also includes a fourth function 358, which may convert the percentage of RUL (y) to a remaining useful life in time, such as days or weeks of expected remaining useful life.

FIG. 14 shows a graph plotting number of cycles to failure as a function of average temperature in degrees C. and as a function of temperature variation in degrees C.

In some embodiments, Miner's rule for modeling cumulative damage may be used to calculate the degradation of the material in the powertrain component. Miner's rule may include the following equation (3):

$${N}_{Damage} = ( \frac{{N}_{f}}{{N}_{k}} \cdot {( \frac{{σ}_{a}}{{σ}_{f}} )}^{m} ) \qquad ( 3 )$$

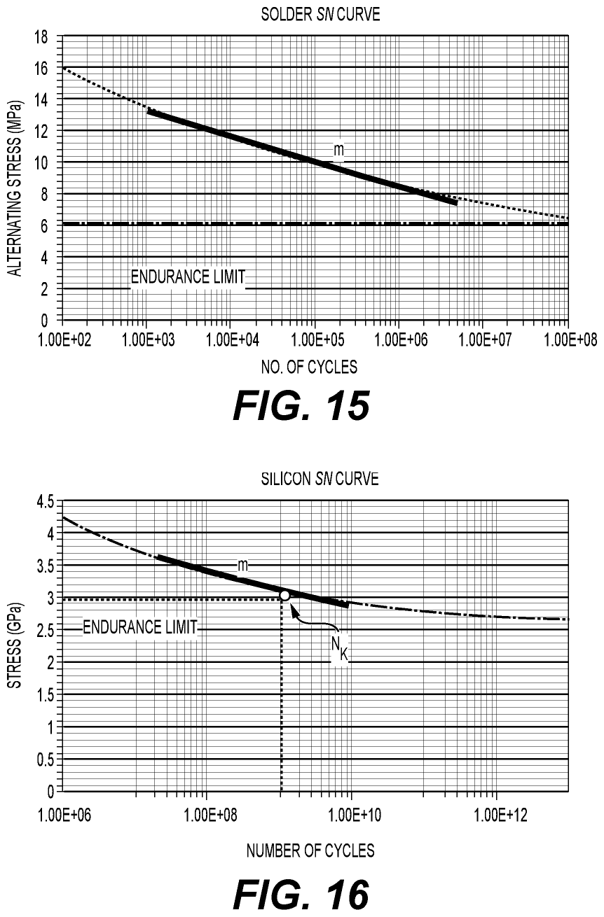

Miner's rule may be modeled using an SN curve plot of the magnitude of an alternating stress versus the number of cycles to failure for a given material. FIGS. 13-14 show examples of such SN plots, where FIG. 15 shows an SN curve for solder in a Si-IGBT device, and FIG. 16 includes an SN curve for silicon material in a Si-IGBT device.

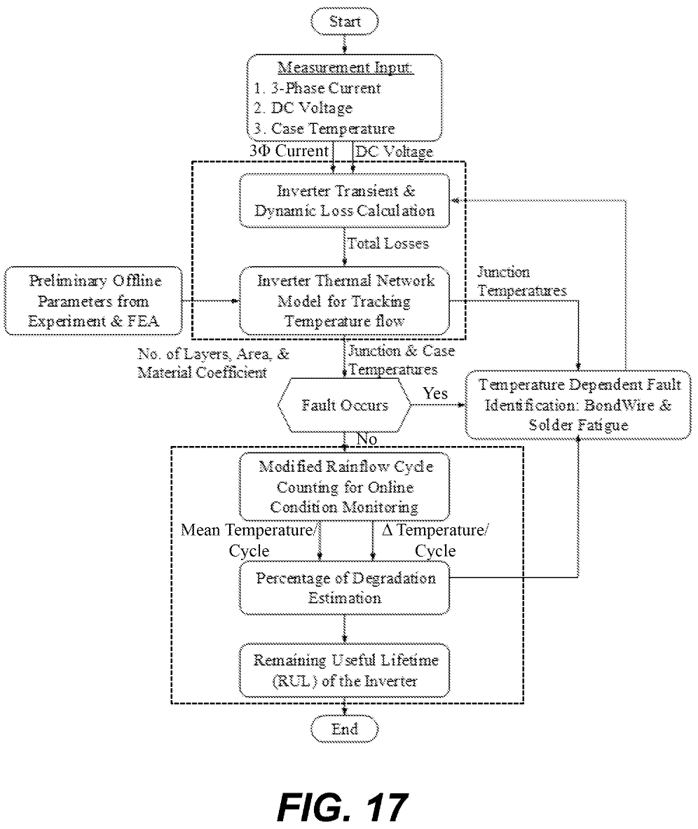

The present disclosure provides a unique SOH monitoring technique incorporating temperature dependent material degradation. Towards the objective, a novel three-dimensional thermal network model has been developed considering semiconductor device cross coupling and packaging material degradation. Subsequently, a case temperature-based fault identification model has been developed. Furthermore, turn-on voltage-based fault classification model has been introduced. Finally, a modified cycle counting method has been developed for online SOH monitoring. FIG. 17 shows a flowchart illustrating steps in a method for monitoring and characterizing SoH of power modules of an inverter. The developed model may be applicable to motor winding insulation and rotor magnet SOH monitoring.

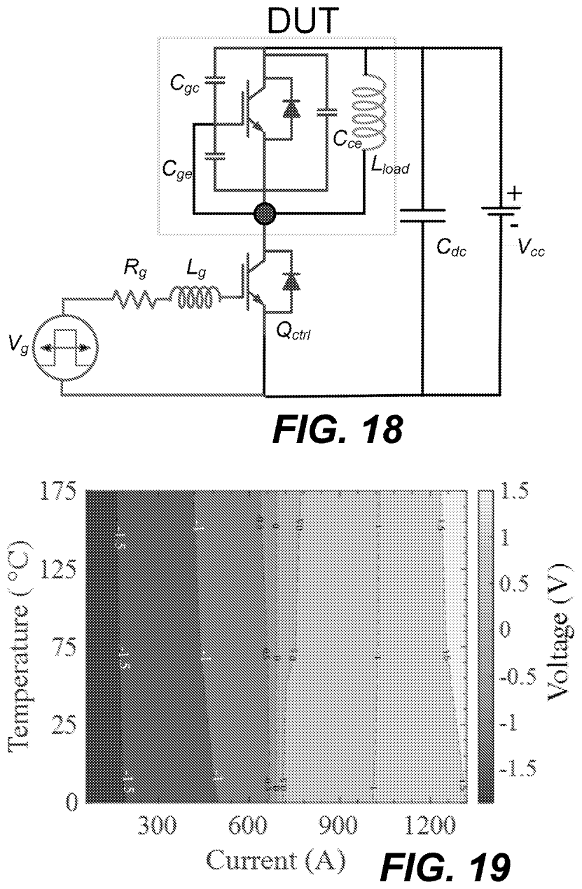

The heat loss identification method is developed using double pulse test (DPT) method. This method combines both steady-state and transient conditions. FIG. 18 shows schematic diagram of a circuit configured to apply a double pulse test (DPT) to a device under test (DUT). The characterization experiment has been conducted for various junction temperature by adjusting the coolant temperature to incorporate the temperature effect into electrical characteristics. Additionally, semiconductor switching characteristics are obtained with varying DC voltage through DPT for further improvement. Subsequently, the characterization method has been improved by applying DPT method for all the semiconductor switches in the power module to consider imbalanced losses due to manufacturing uncertainties.

FIG. 19 shows a graph of voltage and current characteristics of an IGBT-diode power module. Switching and conduction losses of the IGBT-diode power module may be described by equations (4) and (5), below:

$$\{ \begin{matrix}{P}_{sw , Q} = {F}_{sw} \cdot ( {E}_{on} + {E}_{off} ) \cdot \frac{1}{2 π} \cdot {( \frac{{I}_{peak}}{{I}_{ref}} )}^{{K}_{i}} \cdot {( \frac{{v}_{cc}}{{v}_{ref}} )}^{{K}_{v}} \cdot ( 1 + {T}_{{C}_{sw , Q}} ( {T}_{j} - {T}_{j , int} ) ) \cdot γ ( {K}_{i} ) \\ {P}_{sw , D} = {F}_{sw} \cdot {E}_{rr} \cdot \frac{1}{2 π} \cdot {( \frac{{I}_{peak}}{{I}_{ref}} )}^{{K}_{i}} \cdot {( \frac{{v}_{cc}}{{v}_{ref}} )}^{{K}_{v}} \cdot ( 1 + {TC}_{sw , Q} ( {T}_{j} - {T}_{j , int} ) ) \cdot γ ( {K}_{i} )\end{matrix} \qquad ( 4 )$$

$$\{ \begin{matrix}{P}_{cond , Q} = \frac{1}{2} ( \frac{{U}_{ce , o}}{π} \hat{i} + \frac{{r}_{ce}}{4} {\hat{i}}^{2} ) + M \cdot cos θ ( \frac{{U}_{ce , o}}{8} \hat{i} + \frac{{r}_{ce}}{3 π} {\hat{i}}^{2} ) \\ {P}_{cond , D} = \frac{1}{2} ( \frac{{U}_{fo}}{π} \hat{i} + \frac{{r}_{f}}{4} {\hat{i}}^{2} ) + M \cdot cos θ ( \frac{{U}_{fo}}{8} \hat{i} + \frac{{r}_{f}}{3 π} {\hat{i}}^{2} )\end{matrix} \qquad ( 5 )$$

Here, P_{sw,Q}, and P_{cond,Q} are the switching and conduction loss of individual semiconductor chip. Iₚₑₐₖ, and I_{ref} represent the load peak current and initial current. Similarly, v_{cc}, and v_{ref} are the collector voltage and reference voltage at initial temperature. Kᵢ and Kᵥ represent the fitting coefficients. T_{csw,Q} is the temperature coefficient. Tⱼ and T_{j.int} are the actual and initial temperature. In (2), U₀, and r_{ce} represent IGBT on-state voltage and resistance.

In order to obtain an accurate temperature information in the power module for real-life application a circuit-based RC network is being represented. Compared to the vastly used Foster network model, the Cauer thermal network model is employed due to improved temperature tracking with accurate heat distribution. The preliminary model is developed considering geometry and material properties for this research to represent physical characteristics of the power module. The generated heat due to loss is distributed to the rest of the semiconductor power module. Therefore, an analytical thermal network model has been developed to identify heat propagation and distribution of the IGBT semiconductor power module. Thus, a Cauer thermal network model is developed to track the temperature differences at each individual layer of the PM towards estimating SOH. The thermal network model is being implemented considering the sample IGBT power module (PM) 50, which may include a Direct Bonded Copper (DBC) substrate.

An equivalent RC circuit model of the IGBT PM calculated based on materials and geometry such as area, temperature coefficients, conductivity, is described in equations (6) and (7), below:

$${R}_{th} = \sum \frac{1}{k} \cdot \frac{d}{A} \qquad ( 6 )$$

$${C}_{th} = \sum {c}_{h} \cdot ρ \cdot d \cdot A \qquad ( 7 )$$

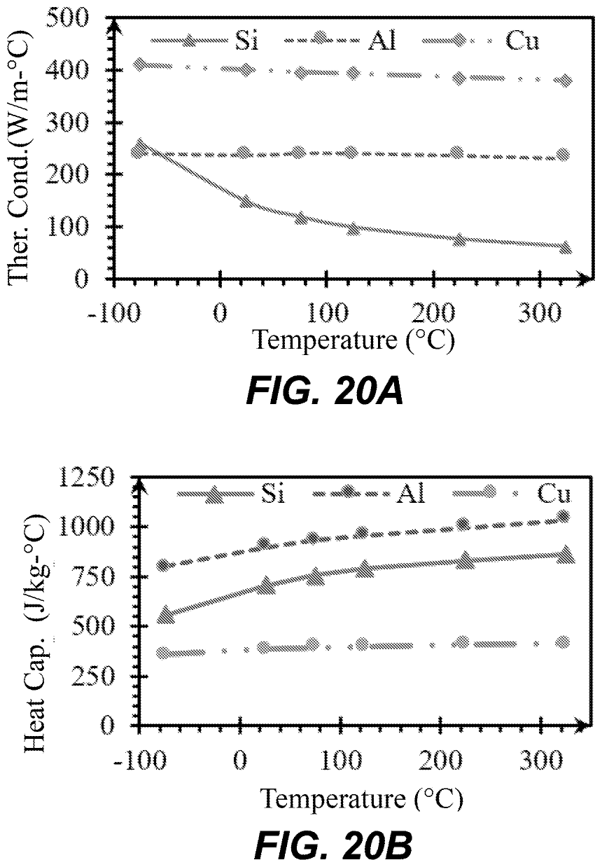

Here, d, K, p, cₕ, and A represent the material thickness, thermal conductivity, material density, specific heat capacity, effective heat propagation area. The effective heat propagation area is directly related to change in RC values and plays a significant role in temperature identification during material degraded and faulty conditions. Additionally, temperature has a substantial impact on the specific heat and thermal conductivity as in FIGS. 20A-20B, which indicate temperature rise due to material aging. This change in material substances can be represented as polynomial fitting function with respect to its' corresponding junction temperature as in equation (8), below:

$$f ( {T}_{j , m = S A Cu} ) \text{?} = {p}_{1} \cdot {T}_{j , m}^{4} + {p}_{2} \cdot {T}_{j , m}^{3} + {p}_{3} \cdot {T}_{j , m}^{2} + {p}_{4} \cdot {T}_{j m} \text{?} + {p}_{5} \qquad ( 8 )$$

$$\text{?} \text{indicates text missing or illegible when filed}$$

where the junction temperature Tⱼ is considered to be the respective material temperature and p1 to p5 are the fitting coefficients defined from the characteristics curve.

### Thermal Impedance Identification Considering Module Packaging Material Degradation:

To this point, temperature variation has been observed with the developed Cauer thermal network model with the power module 50 in a healthy condition. However, in real life situations, thermal model parameter changes as a result of temperature coefficient mismatch due to heat transfer between two different layers and material degradation. Therefore, it is significant to consider material degradation in thermal model for long time temperature estimation. Thus, the thermal properties of the developed model have been updated to equation (9), below:

$$\{ \begin{matrix}{R}_{th} = {\sum }_{i = 1}^{7} {α}_{1} {R}_{th , 1} + … … + {α}_{i} {R}_{th , i} \\ {C}_{th} = {\sum }_{i = 1}^{7} {α}_{1} {C}_{th , 1} + … … + {α}_{i} {C}_{th , i}\end{matrix} \qquad ( 9 )$$

A new constant coefficient, αᵢ has been introduced to incorporate the aging factor to individual material layers of the power module. The coefficient has been identified considering the amount of utilized lifecycle from the total lifetime calculated based on temperature stress. The coefficient updates in an iterative process for each load cycle. The aging factor is updated for each custom designed load cycle. Although, this load cycle is routinely designed following the power cycling procedure for accelerated degradation with maximum temperature stress based on the semiconductor power limit defined by the manufacturer.

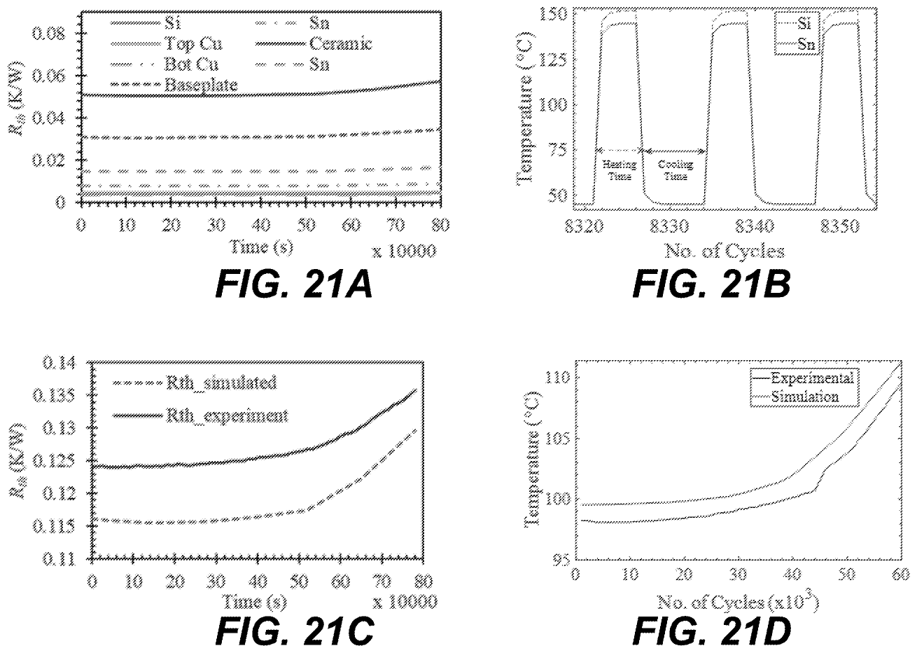

In the provided thermal parameter identification model, material aging has been observed for each layer of the power module 50 towards identifying the change in thermal characteristics as in FIG. 21A using power cycling test method. The resultant thermal resistance has been compared with the experimentation in FIG. 21C; however, small differences are noticed due to temperature measurement error. The differences are reflected in temperature extraction as represented in FIG. 21D.

### Online Case Temperature-Based Fault Identification:

Semiconductor module case temperature monitoring is commonly used for fault indication. In this process, thermal network models such as Foster or Cauer network model are developed to estimate junction and case temperature of the power module 50. The solder fatigue is one of the most important packaging faults, which can be detected observing case temperature. As shown in FIG. 2, the power module 50 contains two solder layers; the top solder layer (i.e. the second solder layer 62) is adjacent to the semiconductor chip 64, and the bottom solder layer (i.e. the first solder layer 54) is on the baseplate 52 of the power electronic module 50. Compared to the top solder layer, the baseplate adjacent solder (i.e. the first solder layer 54) is in critical condition during continuous change in temperature. Due to temperature fluctuation, thermo-mechanical stress is applied on the solder layer resulting fast material degradation, which leads to solder cracks. This crack reduces the effective heat propagation routes from the semiconductor chip 64 to the baseplate 52, increasing thermal impedance. Subsequently, the increase in temperature at the junction of the chip 64 would accelerate other failures such as bond wire fatigue.

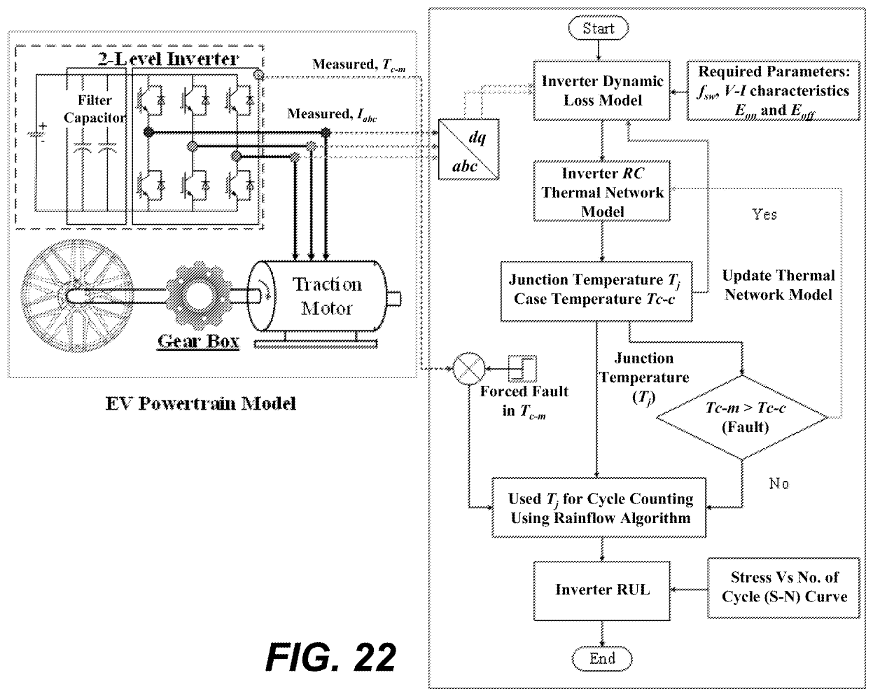

To identify the solder fatigue, case temperature T_{c} can be directly measured, comparatively easier than measuring junction temperature Tⱼ. The variation in case temperature T_{c} is observed to calculate and track the change in thermal impedance based on the effective heat propagating area. The change in total thermal impedance of over 20% indicates a significant fault in the power module as in FIG. 21C. Therefore, this change in thermal resistance is considered as a signature to identify solder fatigue. However, the measured case temperature can be affected due to other heat sources. Also, an estimated case temperature Toc calculated with the thermal network model is continuously compared with the measured case temperature Tom to identify increase in temperature during faults. FIG. 22 shows a schematic diagram including a flow chart illustrating a method for identifying a temperature-based packaging fault in an inverter.

### Turn-on Voltage Mapping Towards Semiconductor Packaging Related Fault Identification and Classification:

The conventional fault identification considers the increase in case temperature. However, this method can only identify general faults along with the solder degradation fault, which can be affected by other heat sources or faults. Therefore, in this section an additional fault index has been introduced such as semiconductor switching turn-on voltage to separate bond wire fatigue from general faults.

To identify the bond wire fatigue, semiconductor turn-on voltage is captured considering change in collector currents and junction temperature. The VI characteristics has been defined with multiple points for improved accuracy conducting experiment in continuous current conduction mode. FIG. 23 shows a schematic diagram of a circuit for measuring turn-on voltage of a semiconductor device including an IGBT and a diode. The voltage measurement circuit of FIG. 23 may be implemented on a gate driver board that is configured to control operation of the semiconductor device.

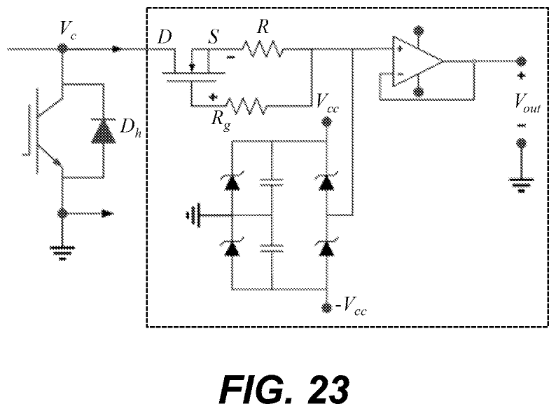

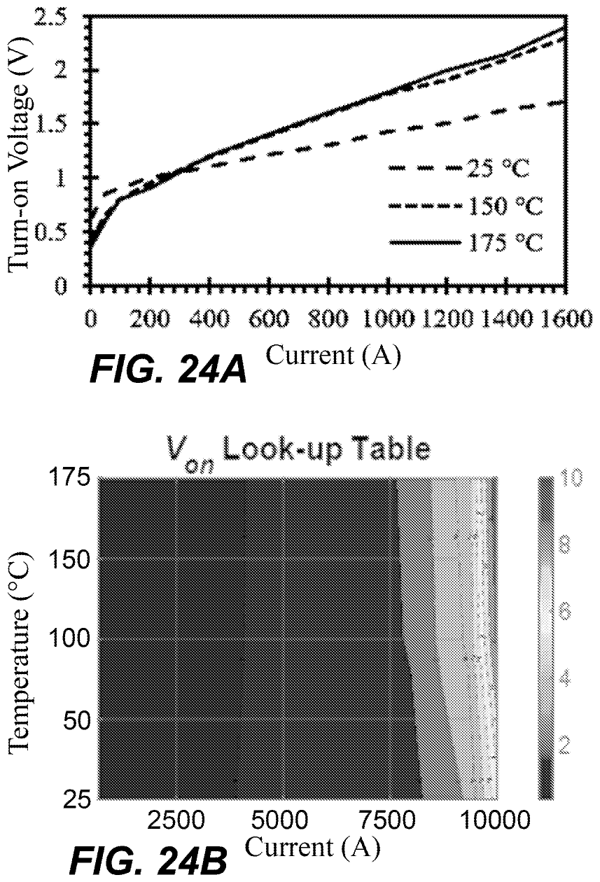

The collector current has been swept from zero to rated condition of the test semiconductor. The heatsink temperature is changed after every set of current sweeps to adjust to the selected junction temperatures. FIG. 24A shows the VI characterization curves of the test semiconductor for junction temperature 25° C., 150° C., and 175° C. FIG. 24B shows a complete characteristics map using linear interpolation to estimate the voltage values. The characteristics curve shows the change in collector-emitter voltage with junction temperature, and current. However, the intersection points in the characteristic curve are independent of temperature, which is mostly known as inflection points.

For the preliminary analysis and validation of turn-on voltage extraction, the power cycling test method is applied. The detail of the experimental procedure is provided in the next section. As previously mentioned, the initial LUT map has been stored to identify initial turn-on voltage based on the collector current and junction temperature. Based on the chip layer degradation calculated in equation (13), the increase in turn-on voltage is represented in equation (10), below. With the developed method, the increase in turn-on voltage can be estimated in degraded conditions.

$${v}_{ce , on} = {v}_{ce , on \_ chip} + {i}_{c} \cdot {α R}_{eq} \qquad ( 10 )$$

Here, V_{ce,on_chip} represents the turn-on voltage at the initial temperature. I_{c} is the collector current and R_{eq} is the equivalent resistance containing both chip and bondwire resistances. However, the change in turn-on voltage can be influenced by the increase in junction temperature due to solder layer degradation. Therefore, to neglect the influence of temperature, bondwire fatigue is identified on inflection point in FIG. 24A.

### Online State-of-Health (SOH) Monitoring:

The degradation of the power module materials is directly related to temperature variation. Therefore, the junction and case temperature dependent device power module degradation model has been developed considering the material and electrical properties. The junction temperature has been extracted from the thermal network model due to load variation.

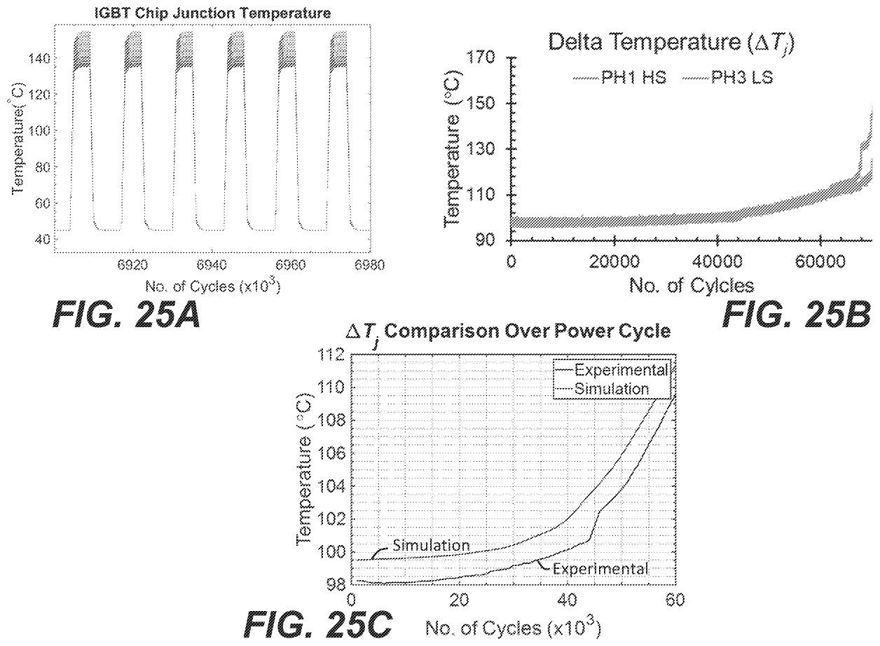

FIG. 25A shows a graph illustrating IGBT junction temperature over a number of cycles. FIG. 25B shows a graph illustrating difference in junction temperature over a number of cycles. FIG. 25C shows a graph illustrating simulated and experimental (measured) differences in junction temperature over a number of cycles.

Cycle counting method is used to identify the degradation rate. Coffin-Manson law is a widely accepted cycle counting method. The conventional cycle counting method is expressed in equation (11), below.

$${N}_{f} = S \cdot Δ {T}_{j}^{α} \cdot exp ( \frac{{E}_{a}}{{k}_{B} \cdot {T}_{m}} ) \qquad ( 11 )$$

The method of equation (11) uses the parameter of temperature sweep and the mean temperature. Also, the general model uses the technology scaling factor, energy dissipation per electron, and Boltzman constant. Rainflow algorithm is used for finding maxima and minima of the temperature cycling profile. The conventional method uses the extracted data to identify the number of full and half cycles. Also, the number of accounted cycles include the information about minimum and maximum temperature sweep values and the mean of individual cycles.

Here, the N_{f} represents the number of cycles to failure, S represents the scaling factor, Ea is the active energy, and k_{B} is the Boltzman constant. However, the material degradation is also dependent on the switching turn-on delay time (tₒₙ), voltage (V_{c}) and current (I_{B}) across each of the bond wires, and the bond wire ratio (D). Therefore, to improve the accuracy of the number of cycles counting model, the factors are considered in equation (12), below.

$${N}_{f} = S \cdot {Δ T}_{j}^{α} \cdot exp ( \frac{{E}_{a}}{{k}_{B} \cdot {T}_{m}} ) \cdot {t}_{on}^{{β}_{1}} \cdot {I}_{on}^{{β}_{2}} \cdot {V}_{c}^{{β}_{3}} \cdot {D}^{{β}_{4}} \qquad ( 12 )$$

where β represents the exponential factor.

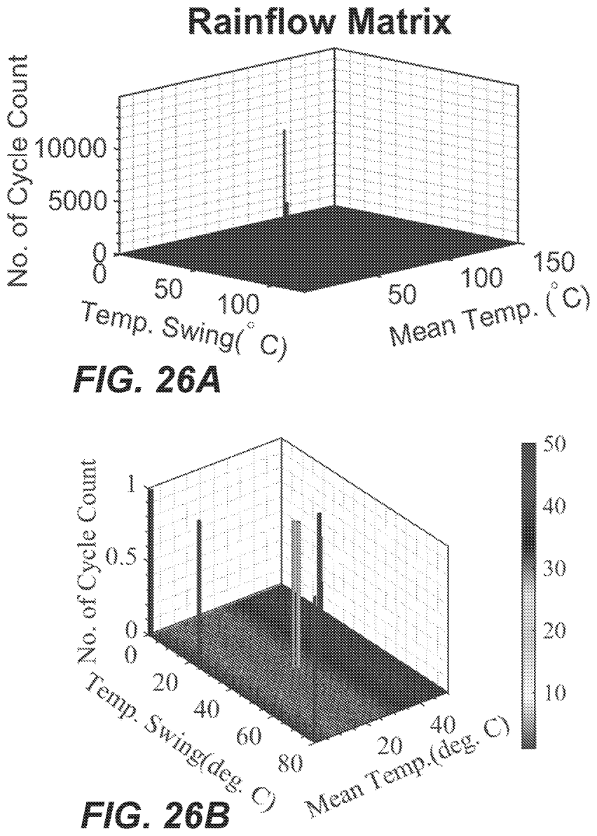

FIG. 26A shows a graph illustrating a total number of lifecycles as a function of each of average temperature and difference in temperature. FIG. 26B shows a graph illustrating degradation for Si and solder (Sn) layers, over a number of cycles. FIGS. 26A-26B show identification of the full and half cycles from the extracted temperature profile in matrix format. FIGS. 26A-26B show the number of repetitive cycles in the operation with respect to the temperature swing and the mean temperature. The total number of cycles is summed up to identify the number of cycles to failure. The provided method may compare a number of cycles to failure from the initial condition of the power module to the number of cycles to failure due to the applied load variation.

Miner's rule, which is used to identify the degradation of the materials, is described in equation (13), below:

$$Damage = {\sum }_{i = 1}^{n} \frac{{N}_{i}}{{N}_{f}} \times 100 \% \qquad ( 13 )$$

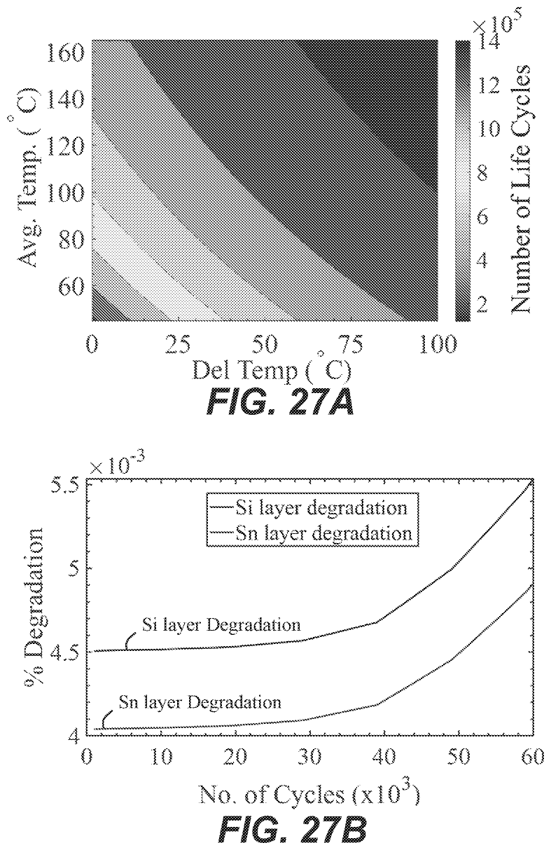

FIG. 27A shows a graph illustrating a total number of lifecycles as a function of each of average temperature and difference in temperature. FIG. 27B shows a graph illustrating degradation for Si and solder (Sn) layers, over a number of cycles.

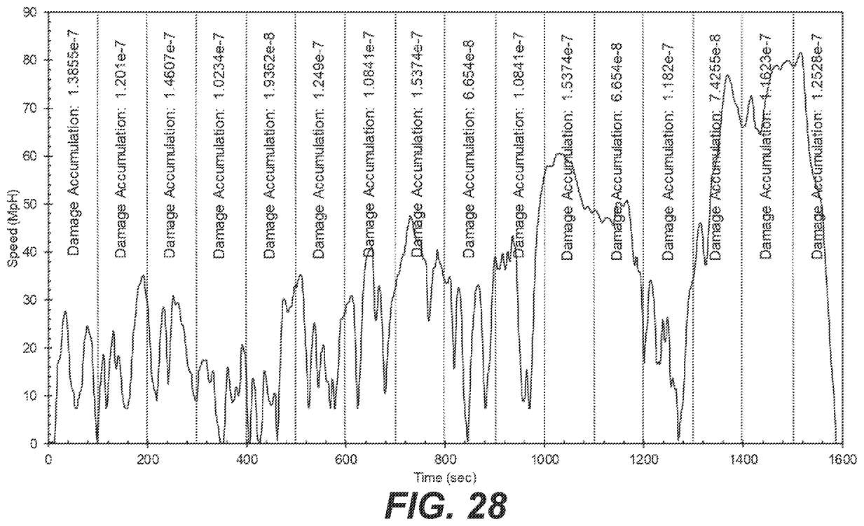

The following results show the continuous damage accumulation in a drive cycle profile. FIG. 28 shows a graph illustrating accumulated material degradation of a silicon layer in online condition. FIG. 28 shows the continuous calculation of Si-chip damage over a user defined time split. The process has been repeated to observe the degradation and stored for total accumulated damage.

### Power Cycling Test Procedure for SOH Monitoring:

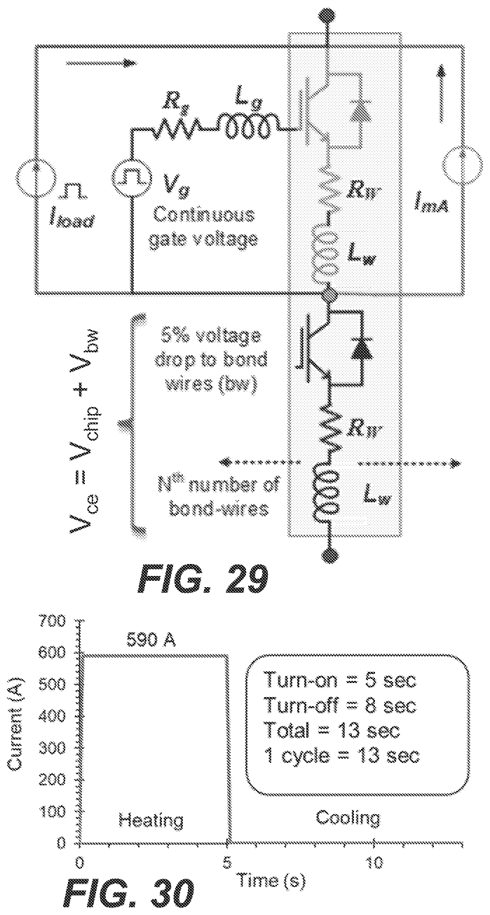

FIG. 29 shows a schematic diagram of an applied power cycling test a circuit for SOH monitoring. High power (130 KW) EV grade IGBT PM has been selected for the analysis as shown in FIG. 29. Device model has been created with its' electrical and thermal characteristics to identify accurate heat loss. Constant load current is applied as 590 A. The total operation has been selected as 13 seconds, in which 5 seconds for heating time and 8 seconds for cooling time. The process has been repeated 70,000 times to observe the gradual degradation of the power module materials. Experiment has been conducted for equal number of load cycles for validation. The test power module has been cooled with water glycol and ambient temperature is selected as 45° C. Thermocouple has been placed near semiconductor chip for accurate temperature measurement. Instantaneous temperature variation is presented in FIG. 30, where a cycle is represented with total heating and cooling time.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for state-of-health monitoring of a powertrain component in an electric vehicle system, comprising:
determining an equivalent circuit model of the powertrain component;
modeling heat losses in the powertrain component considering both transient and steady-state conditions;
modeling heat flow through the powertrain component based on one or more material properties of the powertrain component;
determining, based on the modeling the heat flow through the powertrain component, a temperature of a particular structure within the powertrain component; and
determining, using a Rainflow algorithm, a number of temperature cycles until failure of the particular structure based on the temperature of the particular structure.

2. The method of claim 1, wherein determining the number of temperature cycles until failure includes determining an applied stress in the particular structure.

3. The method of claim 2, wherein determining the applied stress in the particular structure includes using an Arrhenius model of a material of the particular structure.

4. The method of claim 1, wherein determining the number of temperature cycles until failure includes using a Coffin-Manson relationship.

5. The method of claim 1, further comprising: calculating a degradation of a material in the powertrain component.

6. The method of claim 1, wherein calculating the degradation of the material in the powertrain component includes applying Miner's rule for modeling cumulative damage.

7. The method of claim 1, further comprising: determining a remaining useful lifetime of the powertrain component.

8. The method of claim 1, wherein the particular element is a junction in a power electronic device.

9. The method of claim 8, wherein powertrain component includes an inverter power module, and the power electronic device includes one of a switch and a diode.

10. A system for state-of-health monitoring of a powertrain component in an electric vehicle system, comprising:
a processor; and
a memory including instructions that, when executed by the processor, cause the processor to:
determine an equivalent circuit model of the powertrain component;
determine an estimate of heat losses in the powertrain component considering both transient and steady-state conditions;
determine an estimate of heat flow through the powertrain component based on one or more material properties of the powertrain component;
determine, based on the estimate of the heat flow through the powertrain component, a temperature of a particular structure within the powertrain component; and
determine, using a Rainflow algorithm, a number of temperature cycles until failure of the particular structure based on the temperature of the particular structure.

11. The system of claim 10, wherein determining the number of temperature cycles until failure includes determining an applied stress in the particular structure.

12. The system of claim 11, wherein determining the applied stress in the particular structure includes using an Arrhenius model of a material of the particular structure.

13. The system of claim 10, wherein determining the number of temperature cycles until failure includes using a Coffin-Manson relationship.

14. The system of claim 10, wherein the instructions further cause the processor to: calculate a degradation of a material in the powertrain component.

15. The system of claim 10, wherein calculating the degradation of the material in the powertrain component includes applying Miner's rule for modeling cumulative damage.

16. The method of claim 1, wherein modeling the heat flow through the powertrain component includes using a Cauer thermal network model having a plurality of resistor-capacitor (RC) components each representing an interaction between two corresponding portions of the powertrain component.

17. The method of claim 1, further including:
measuring a measured case temperature of the powertrain component;
determining, based on the estimate of the heat flow through the powertrain component, an estimated case temperature of the powertrain component, wherein the estimated case temperature of the powertrain component is different than the temperature of a particular structure within the powertrain component; and
comparing the measured case temperature of the powertrain component to the estimated case temperature of the powertrain component to determine the measured case temperature of the powertrain component exceeding the estimated case temperature of the powertrain component.

18. The method of claim 17, wherein modeling the heat flow through the powertrain component includes using a thermal network model representing the powertrain component; and
wherein the method further includes updating the thermal network model in response to determining the measured case temperature of the powertrain component exceeding the estimated case temperature of the powertrain component.

19. The method of claim 17, wherein modeling the heat flow through the powertrain component includes using a Cauer thermal network model having a plurality of resistor-capacitor (RC) components each representing an interaction between two corresponding portions of the powertrain component; and
wherein the method further includes updating a value of at least one of the plurality of RC components within the Cauer thermal network model in response to determining the measured case temperature of the powertrain component exceeding the estimated case temperature of the powertrain component.

20. The method of claim 17, further including determining, based on the measured case temperature of the powertrain component and based on the estimated case temperature of the powertrain component, the measured case temperature of the powertrain component being not indicative of a fault, and
wherein the determining the number of temperature cycles until failure of the particular structure based on the temperature of the particular structure and using the Rainflow algorithm is performed only in response to determining the measured case temperature of the powertrain component being not indicative of a fault.
